(19) United States
(12) Patent Application Publication
(10) Pub. No.: US 2006/0139463 A1
(43) Pub. Date: Jun. 29, 2006

(54) Multi-camera solution for electronic devices

(75) Inventor: Tomi Heinonen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/317,914

(22) Filed: Dec. 22, 2005

(30) Foreign Application Priority Data
Dec. 23, 2004 (WO) PCT/IB04/04265

(51) Int. Cl. H04N 5/262

(52) U.S. Cl. 348/239

(57) ABSTRACT

There is disclosed a method, electronic device and computer program product for handling video streams of two or more cameras in an electronic device, wherein at least first and second video streams (1, 1′, 1″; 2, 2′, 2″) are captured (202, 204) by first and second cameras and integrating (206) said first and second video streams into an integrated video stream.

### BACKGROUND OF THE INVENTION

The present invention relates to a method of using two or more cameras in an electronic device and to a corresponding electronic device comprising a twin- or multi-camera solution. Particularly it concerns using two or more cameras simultaneously while utilizing a single camera interface and video processing/coding pipeline.

The use of cameras in electronic devices like mobile phones and recently also PDAs has become very common today. At the beginning of the use of this technology in mobile devices such cameras were used for taking still pictures, for example to be used in an MMS. However, with the advance in technology they are more and more also used for capturing video clips.

With some forms of phone housings, particularly flip-type phones, the problem did arise to provide a possibility to take a picture (or video) in the closed position as well as in the open position. Additionally the users wanted to take pictures of themselves while also being enabled to take pictures of the scenery they were looking at, i.e. it should be possible to capture pictures in two directions often being apart from one another by even up to 180°. Also with “rigid” phone housings (“brick type”) the wish did arise to be able to take both pictures of the user of the phone (self-portrait mode) as well as pictures from the user's point of view. To achieve this certain means were used, for example rotatable cameras or camera optics. While this on the one hand seems to be an appropriate solution the amount of mechanically movable parts in a mobile electronic device should on the other hand be kept as low as possible. Such mechanical solutions are not very comfortable to be operated by the user and take up considerable space in the device that is wasted instead of utilizing it for other more useful purposes. Also such constructions with movable cameras are prone to wear when used frequently.

Another solution is therefore to provide mobile phones with two cameras in a single device, for example one pointing in the forward direction to take pictures like with a conventional camera, and another one for taking pictures of the person holding the device. Such twin cameras can be integrated in the housing more conveniently than rotatable cameras or the like, and of course provide for a more robust implementation. However this also presents several disadvantages compared to rotatable or otherwise movable cameras. The costs of an accordingly equipped phone or generally mobile electronic device will apparently be higher as some hardware parts of the cameras have to be provided in duplicate as well. Commonly the manufacturer will simply purchase two independent and substantially complete camera modules to be integrated into the device.

Providing two cameras involves numerous challenges concerning the camera interface, the pre-processing and video coding pipeline, and the physical size, since conventionally the application engine only supports one camera at a time. If two cameras are connected to the system new problems arise in terms of pre-processing and video encoding. Two separate cameras can also be difficult to be housed inside a mobile electronic device due to space restrictions.

The patent application GB 2 394 381 A describes a folding/twisting mobile phone with two housing parts, and comprising two cameras. Only one camera at a time is used, and the switching between the two cameras is performed utilizing a sensor for detecting a positional relation between the two parts of the housing. According to the detected position the operation of the first or second camera is started/stopped.

The patent application GB 2 379 828 A describes a mobile phone with two cameras that is enabled to take photographs from the front and the rear end of the phone, respectively. Here two camera modules are provided back by back, or one camera module and a switchable light deflection device, for enabling the phone to take pictures either from the front or the rear side. The user can switch to either camera view mode to take pictures from the respective side of the phone.

While there are mobile electronic devices known which comprise two cameras they conventionally can not be operated simultaneously to provide two separate video streams, as there is only provided one camera interface and one signal processing path.

Using cameras only for taking (still or single) pictures will assumedly not lead to a big demand of the user to simultaneously take a picture of himself as well as the scene he is looking at, as it will be far more comfortable (concerning focusing, zooming and selecting the wanted part of the picture) to do this successively, i.e. one picture after the other. However with the possibility to record video clips such a demand can arise.

### BRIEF SUMMARY OF THE INVENTION

Therefore it is advantageous to provide two cameras in a single mobile electronic device enabling a user to record two video clips or streams simultaneously.

For example the user might wish to record the scene he watches while at the same time recording his reaction to it. Such a feature may be useful for a kind of video-conferencing application, e.g. for simultaneously showing presented sketches or drawings while at the same time displaying the image of the person actually reporting. Being able to simultaneously watch the person speaking can be advantageous not only to for example deaf people, but also improve the understanding of other listeners. Another application in the leisure area may be to record taking a rollercoaster ride and at the same time recording the face of the passenger himself, which will greatly improve the impression that is created compared to showing only what the passenger sees.

The present invention aims at suggesting a method for a more efficient use of two cameras in a single device that can better meet the above discussed demands. A corresponding electronic device is furthermore presented by the invention, which provides two cameras being operable simultaneously, while at the same time keeping the amount of hardware components as low as possible. Both the method and the device of the present invention do not require major changes to the application engine/software platform, camera interface and video processing/coding pipeline of electronic devices to be equipped accordingly.

According to an aspect of the present invention a method for handling video streams of two or more cameras in an electronic device is provided. The electronic device may be a mobile phone, a personal digital assistant (PDA) or a portable or non-portable computer. The method comprises capturing at least first and second video streams by first and second cameras, and integrating said at least first and second video streams into an integrated video stream. This method enables the use of a single camera interface and video processing pipeline for using two or more cameras simultaneously, which enables devices operating correspondingly to be produced with a minimum amount of additional hardware components compared to single-camera implementations. Also this method enables, by minor changes in the application engine or software platform, to handle two or more video streams simultaneously.

In an exemplary embodiment the integrating is performed by generating an integrated video stream, wherein frames of said integrated video stream are alternately provided by frames of said at least first and second video stream, respectively. For example, in the case of two video streams, odd number frames of said integrated video stream may be provided by frames of said first video stream and even number frames may be provided by frames of said second video stream or vice versa. This may of course be extended to n video streams (with n≧2), for example such that every n-th frame of the integrated video stream is provided by a frame of the n-th video stream. Alternately providing frames may also comprise alternately providing sets of frames. For example, first five frames of said integrated video stream may provided by frames of said first video stream and the next five frames may be provided by said second video stream or vice versa. This presents a way of performing the integration in a very straightforward manner. Also the dimensions/aspect ratio of the resulting integrated video stream equal those of the at least two original video streams, which can greatly simplify the further processing. However the sampling rate will in certain embodiments of this method be twice that of the original streams.

In an exemplary embodiment the integrating is performed by generating an integrated video stream, wherein sections of a frame of said integrated video stream are provided by corresponding sections of respective frames of said at least first and second video stream, respectively. In a simple case with two video streams this may for example be performed such that one half of the integrated video stream is provided by frames of the first video stream and the other half by frames of the second video stream. This provides for various suitable implementations, depending on the specific application and the size/aspect ratio of the involved video streams. Even complex integrations may be performed that way, e.g. a kind of picture-in-picture mode.

In an exemplary embodiment the—at least two—sections are arranged adjacent to each other. This includes arranging the frames side by side or even being adjacent in a vertical fashion. Which arrangement is best suited for the specific purpose will mainly depend on the aspect ratios involved. For example two 16:9 video streams will assumedly be integrated to form a 16:18 integrated video stream, rather than 32:9. However this way of performing the integration is easy to implement and still provides a great amount of flexibility to adapt to various applications.

In an exemplary embodiment the integrating is performed by generating an integrated video stream, wherein lines of a frame of said integrated video stream are alternately provided by lines of frames of said at least first and second video stream, respectively. For example, in the case of two video streams, odd lines of each frame of said integrated video stream may be provided by lines of frames of said first video stream and even lines may be provided by lines of frames of said second video stream. Alternately providing lines may also comprise alternately providing sets of lines. Advantages of such integration will be discussed below in this description.

In an exemplary embodiment the method further comprises processing said integrated video stream. As will also be explained later certain processing steps can advantageously be performed on the integrated video stream rather than subsequently to the individual separated output streams.

In an exemplary embodiment the method further comprises separating said integrated video stream into first and second output video streams corresponding to said first and second video streams, respectively, to render said first and second output video streams available for further processing, storing or displaying. If no processing was performed on the integrated video stream the output video streams should be identical to the original video streams. However processing may be performed and the output video streams will still correspond to the original video streams when the separation is performed complementary to the integration step.

According to another aspect of the invention a computer program product is provided, comprising program code means for carrying out the method of the invention, when said program product is run on a computer or network device.

According to another aspect of the invention a computer program product is provided, comprising program code means embodied on a computer readable medium for carrying out the method of the invention, when said program product is run on a computer or network device.

According to another aspect of the invention a computer program product is provided, comprising program code, downloadable from a server for carrying out the method of the invention, when said program product is run on a computer or network device. According to a second aspect of the invention an electronic device is provided, which comprises at least first and second optics, for example lenses or lens systems, at least first and second image sensors, wherein said first image sensor is associated with said first optic and said second image sensor is associated with said second optic. The image sensors are adapted for capturing first and second video streams, respectively. The device further comprises a video integrator unit being adapted for generating an integrated video stream of said at least first and second video streams. Such a device can provide the possibility for a simultaneous use of two or more cameras being constituted by the optics and the image sensors, while keeping the number of hardware components low. As described before such simultaneous use enables various advantageous applications, in the business field as well as for leisure or fun activities. Just one example may be SWIS/video telephony applications.

In an exemplary embodiment the video integrator unit is adapted for generating the integrated video stream such that frames of said integrated video stream are alternately provided by frames or sets of frames of said at least first and second video stream, respectively.

In an exemplary embodiment the video integrator unit is adapted for generating the integrated video stream such that sections of a frame of said integrated video stream are provided by sections or sets of sections of respective frames of said at least first and second video stream, respectively.

In an exemplary embodiment the video integrator unit is adapted for generating the integrated video stream such that lines of a frame of said integrated video stream are alternately provided by lines or sets of lines of frames of said at least first and second video stream, respectively.

In an exemplary embodiment of the invention the device the optics are oriented at 180° to each other. This arrangement of the optics is easy to implement and is of course best suited for the purpose of recording the scenery the user sees and at the same time the user himself. It should though be noted that this is just the most typical solution for the mentioned object; it is within the scope of the invention to use also other orientations like approximately 90°, 45°, 135° or other.

In an exemplary embodiment of the invention the device comprises a video processing unit being adapted for processing said integrated video stream. As will be described later there are certain processing methods that may advantageously be performed even on the still integrated video stream rather than conventionally on the separated output video streams.

In an exemplary embodiment of the invention the device further comprises a camera interface for enabling access to said integrated video stream by an application engine of said mobile electronic device. The invention enables the use of just a single interface rather than requiring complicated and costly solutions with two independent interfaces and a processor handling these interfaces. From the viewpoint of the application engine the integrated video stream may be handled as if it were just a conventional video stream. Everything else may easily be handled in software, such that only slight modifications will be necessary to implement a twin- or multi-camera solution of the present invention.

In an exemplary embodiment of the invention the device further comprises a video separator unit adapted for separating said integrated video stream into first and second output video streams corresponding to said first and second video streams, respectively, to render said first and second output video streams available for further processing, storing or displaying. This provides for various applications or uses of the output video streams. A more detailed explanation will be given in the description of the figures.

In an exemplary embodiment of the invention the device is implemented such that said first and second image sensors are combined into an integral image sensor. For a dual camera solution this is of course a possible manner of implementation. This includes the use of a single image sensor in combination with a suitable optical deflection device (to be explained in more detail below), as well as the use of a “double-sided” sensor, i.e. manufactured of silicon with photo-sensitive areas on both sides.

In an exemplary embodiment of the invention the device further comprises an optical deflection element for directing the views viewed by said first and said second optic to said first and said second image sensor, respectively. In this manner a single image sensor may be utilized, even of a principally conventional type, as will become clear from the drawings.

In an exemplary embodiment of the invention the device further comprises a housing, and said first and second optics are incorporated into a retractable element being settable to at least a first and a second position, wherein said optics are at least partially retracted into said housing in said second position and are operable in said first position. For example the first position may be an “open” position, e.g. wherein the retractable element is folded out, and the second position may be a “closed” position, e.g. wherein the retractable element is folded in. This provides a good mechanical solution for protecting the lenses from dirt and scratching while they are not used. The retractable element may either be folded out manually, or an electric motor may serve for this purpose.

In an exemplary embodiment of the invention the device further comprises a switch being adapted to be actuated when said retractable element is set into said first position and/or when said retractable element is set into said second position. This enables automatic activation or de-activation of camera related software applications. Also the camera hardware may be powered only when needed, to save energy which is usually limited in mobile electronic devices.

Said electronic device may be a mobile electronic device such as a mobile terminal, mobile phone, PDA, etc

### BRIEF DESCRIPTION OF THE DRAWING

The invention will be more fully understood by referring to the appended drawings, which are provided only as illustrative examples and which are not intended to limit the invention to specific embodiments depicted. In the drawings

FIG. 1 shows an embodiment of the method according to the present invention;

FIG. 2 illustrates how the invention can be implemented from the point of view of the application engine/software platform of an electronic device;

FIG. 3 shows how two video streams according to the invention can be integrated to provide a single integrated video stream according to an embodiment of the invention;

FIG. 4 shows how two video streams can be integrated to provide a single integrated video stream according to another embodiment of the invention;

FIG. 5 illustrates a possible hardware implementation of a mobile electronic device according to the invention;

FIG. 6 illustrates an alternative hardware implementation of a mobile electronic device according to the invention;

FIG. 7 illustrates still another hardware implementation of a mobile electronic device according to the invention; and

FIG. 8 shows an embodiment of integrating two cameras in the housing of an electronic device according to the invention.

### DETAILED DESCRIPTION OF THE INVENTION

It is to be noted that the invention can also be applied to more than two video streams and more than two cameras. However, for sake of simplicity the further description will refer to two video streams and cameras, respectively.

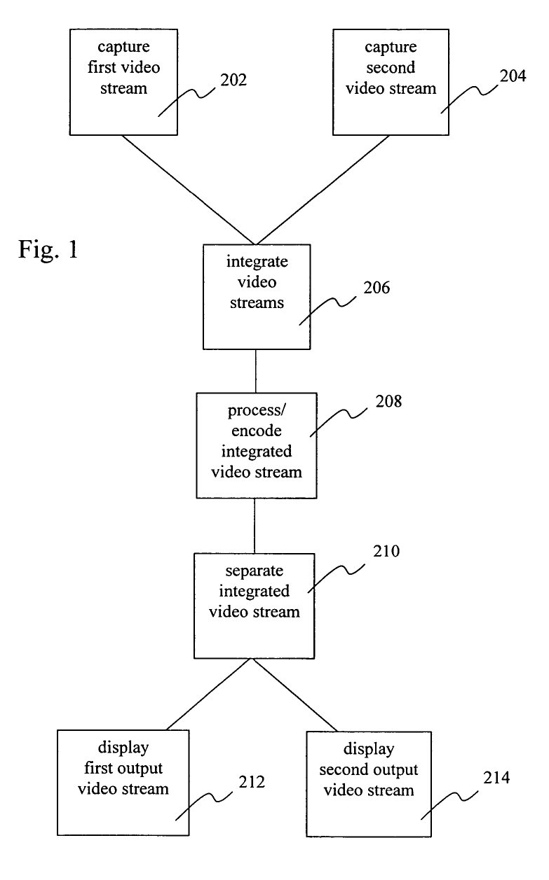

FIG. 1 illustrates how the inventive method of handling two video streams in a mobile electronic device may be implemented. In steps 202 and 204 two video streams are captured or recorded. Next those two video streams are integrated into a single integrated or combined video stream, in step 206. This integrated video stream can now be provided to a camera interface, even if this interface is only adapted to deal with a single video stream. However certain limitations may apply that such an interface is to fulfill, which will be explained later. Step 208 should be seen as optional and may not be present in other possible embodiments of the present invention. In this step a processing may be performed on the integrated video stream, for example subjecting it to an encoding procedure. It should be noted that this step may also include a storing of the integrated video stream in a memory device, e.g. the internal memory of the respective electronic device, or a memory card like MMC or the like.

Next, in step 210, the two video streams are separated from the integrated video stream again. As they may have been subjected to some processing in optional step 208 this must not necessarily lead to two video streams that are identical to the original two video streams, depending on the processing. However, the separation or extraction is substantially performed in a way that is complementary to the integration process. If, as will be explained later, the integration is performed such that respective frames of video streams are combined into a single frame of the integrated video stream there are also implementations conceivable where the integration/separation processes will not be exactly complementary, depending on the actual application. In steps 212 and 214 the two separated video streams are displayed. It is to be understood that displaying is shown for illustrative purposes only and should not be understood in a limiting fashion. Possible alternatives could for example be storing the two video streams in a memory device, subjecting them to further processing, or even treating the two video streams differently (saving one and displaying the other). The latter may for example be useful for recording the video stream corresponding to the user's point of view onto the memory card of the device, while temporarily buffering the video stream showing the user's face in the RAM memory of the device, to let the user decide if he wants to store it also or discard it. This may also be applied to devices being only able to display one video stream, wherein the other video stream is stored to be displayed later.

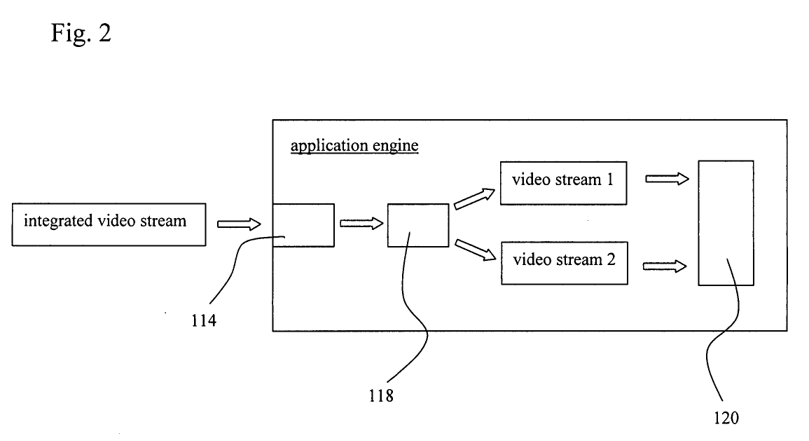

FIG. 2 shows how an application engine or software platform of a mobile electronic device can handle an integrated video stream according to the invention. The integrated video stream is fed into a camera interface 114 serving as the input interface for the video stream. A separator unit 118 operates to separate the two video streams from the integrated video stream. Such a separator unit 118 may be implemented as a kind of pre-processing unit. The separated two video streams are then inputted into an encoding unit 120 performing a desired coding of the video streams, for example performing some compressing to reduce the required bandwidth. Performing the video stream handling in this manner is advantageous as a change is not necessarily needed to the camera interface 114. This provides that the integrated video stream comprises a format that can be processed by the camera interface, particularly concerning frame dimension (aspect ratio, resolution) and sample frequency (frames per second). Then the handling procedure depicted in this figure will require only small changes to deal with the two video streams that may in many cases be made solely in software. Though the situation illustrated here suggests that the encoding unit 120 could encode the two video streams simultaneously it is of course also possible to use some buffer techniques that will be known to an artisan to implement a sequential encoding allowing the use of an encoding unit that is only able to process one stream at a time.

Depending on the kind of encoding that is desired the encoding may even, other than depicted here, be performed on the still integrated video stream. This would of course be advantageous as only one encoder would have to be used. However it strongly depends both on the kind of desired encoding method as well as the way the integrated video stream is composed of the original video streams, if encoding of the still integrated video stream is feasible.

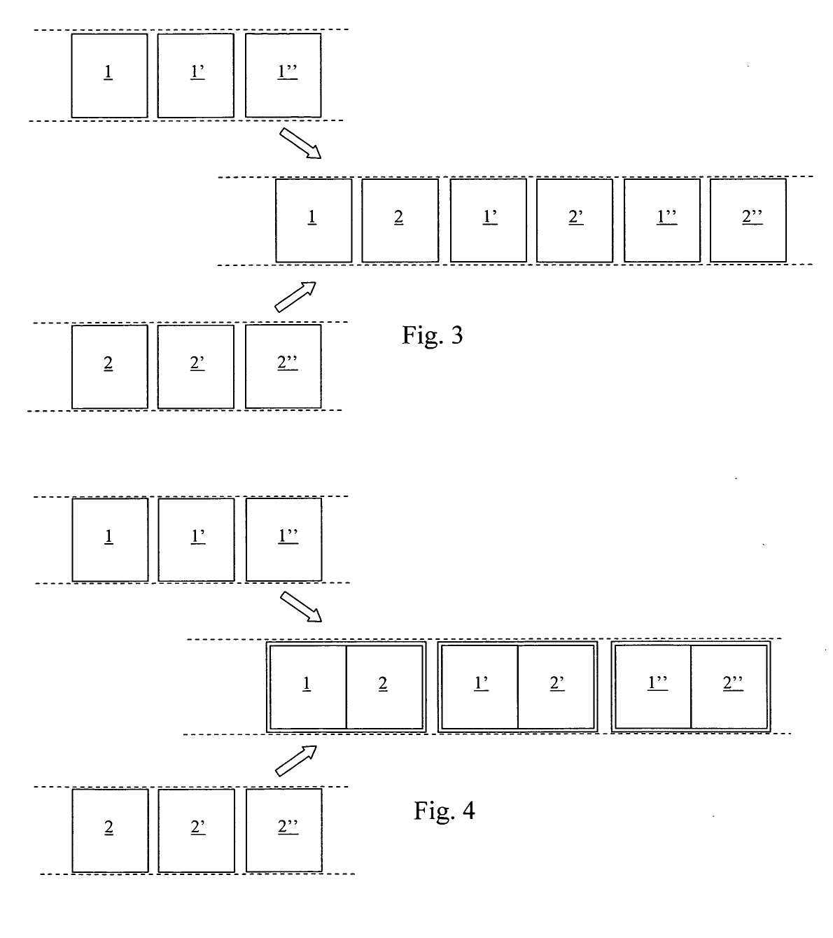

FIG. 3 shows a possible embodiment of integrating two independent video streams, respectively comprising a succession of single frames 1, 1′, 1″ and 2, 2′, 2″, into a single integrated video stream, according to the invention. Here the resulting video stream is composed by using the successive frames of video stream 1 as the odd number frames of the single video stream to be produced, while frames of video stream 2 are used for the even number frames of the resulting video stream. It is to be noted that the integrated single video stream will usually comprise a sampling rate (frames per time unit) that is twice as high as that of the two original streams. This particularly concerns a buffering that may be required in conjunction with the integrating step (frame buffer between the two cameras and the integrator unit). Otherwise a pre-buffer that may be required for the integrated single video stream would start to fill up, as two frames will come in per time unit and only one will be outputted. Though, in special cases it may be useful to use such an approach while accepting that the capacity of the pre-buffer will then limit the recording time of the video clips. For example if the video clips are only to be recorded onto a memory device, like an MMC card or the like, and to be displayed later on this might be sufficient. In this case the buffer capacity could be adjusted to be sufficient for a certain type/size of memory card or device, for example being sufficient for using the built-in memory of the electronic device. An advantage of this method would be that video processing hardware and/or software would only have to deal with a video stream comprising a “normal” sample rate instead of a doubled one.

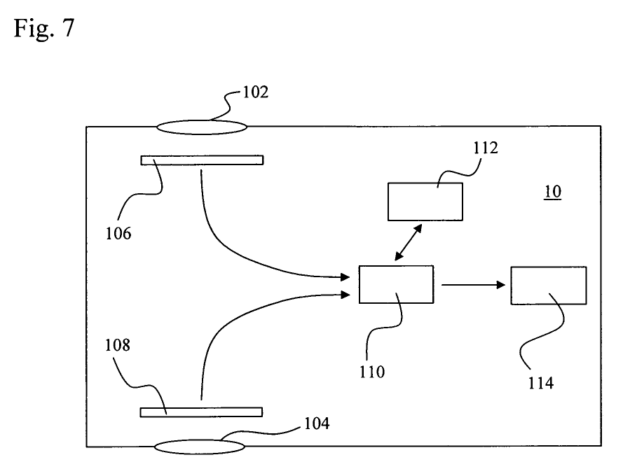

FIG. 4 shows another possible embodiment of integrating two independent video streams, respectively comprising a succession of single frames 1, 1′, 1″ and 2, 2′, 2″, into a single integrated video stream, according to the invention. Here the resulting video stream is composed by having one section of a frame being provided by said first video stream and another section of said frame is provided by said second video stream. In the simplest case this could mean that two video streams comprising frames of equal aspect ratios are put together, either in a vertical fashion (stream 1 provides the upper half of the resulting frame, stream 2 the lower) or a horizontal fashion as depicted in this figure. The decision about which of the possibilities is the most suitable one will depend on the aspect ratios of the original video streams and the desired aspect ratio/dimension of the resulting video stream. The resulting single video stream will in this embodiment have the same sampling rate as the original two video streams, but either twice the height or width, respectively. However, besides the apparent possibilities illustrated yet there may be special cases where also more complicated fashions of “putting together” the frames can be suitable. For example a kind of mode could be applied wherein the sections are even overlapping partly, i.e. one section being “preferred” in that the part of the other sections it overlaps is discarded or overwritten. Also any other suitable geometrical arrangement of the two sections within the resulting frames is possible. The advantage of performing the integrating in this manner is its simplicity, both in integrating as well as in the separating step later on. The sampling rate equals that of the two original video streams. Of course the camera interface and video processing/coding pipeline must be suited to process the resulting frame size and aspect ratio. This embodiment of the inventive method will particularly be useful for the hardware arrangement being depicted in FIG. 7, as such may easily provide a single integrated video stream as required, even without a distinctive preceding integrating step.

Another integration method that is possible within the present invention comprises constituting the integrated video stream by having odd lines being provided by the first video stream and even lines by the second video stream. Although such integration in a kind of “interlaced” fashion may appear more complicated compared with the other methods of the invention there may be special cases wherein the available processing equipment or hardware makes such a method more advantageous though. This particularly concerns possibly required buffering (especially buffer size) and/or the access times of participating memory devices as RAM memories and the like. Here this interlaced way of integrating might help to circumvent certain timing problems that might occur, as the integrating is performed in a line-oriented manner instead of a frame-oriented. Also this might be better suited for cases wherein buffers are too small to buffer whole frames, but are able to buffer frame lines.

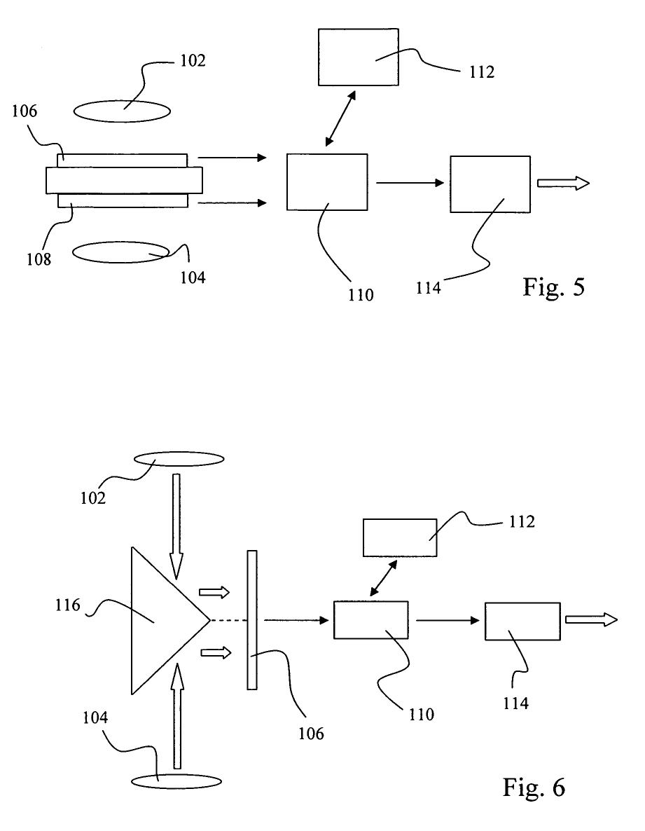

FIG. 5 shows a possible embodiment of the arrangement of two cameras facing in different directions, in this case in opposite directions, according to this embodiment of the invention. Two optics 102, 104, e.g. lens systems, are provided. Between the optics 102, 104 an two image sensors 106, 108 are provided, for example of the CCD or CMOS type facing in the opposite directions. In the context of this invention it would be advantageous to have, instead of two separate image capture sensors, a combined image sensor with two photo-sensitive areas on either side. A corresponding image sensor could be produced using a substrate wherein a photo-sensitive layer is applied on both sides instead of just one as conventionally. The images captured by the two sensors sides 102, 104 are then sent to an integrator unit 110, which is coupled with a memory unit 112 and a camera interface 114. In the integrator unit 110 the two yet separate video streams will be integrated into one single video stream comprising the information of the original two video streams. The camera interface will then enable an electronic device (not shown) to access the single integrated video stream for further processing/displaying. A big advantage of the present invention is that such an interface may be of a type only capable of handling one single video stream instead of two independent streams, due to the performed integration. The only prerequisites are that it should be able to handle the actual aspect ratio/size of the video stream and/or the sample rate (frames per time unit). However this can be implemented far more easily than providing for a handling of two independent video streams. The integrator unit 110 may optionally also comprise certain pre-processing capabilities, or a dedicated pre-processor unit (not shown) may be inserted between integrator unit 110 and camera interface 114 for that purpose.

FIG. 6 shows an alternative embodiment of the arrangement of two cameras according to the invention. Similar to FIG. 5 two camera optics are provided pointing in different directions, for example 180° apart, i.e. back to back. An optical deflection element, for example a prism or suitably formed mirror as depicted in the figure, is provided such that the images viewed by the optics are directed to an image sensor 106. The two sections of this image sensor 106 (in the figure indicated by the dashed parting line) capture the respective images from the first and second optic, respectively. The arrangement depicted here has the advantage that a single image sensor may be used, which hence can be of a conventional type, provided it can handle the required image size. The image sensor already outputs a signal that corresponds to a single video stream as described in conjunction with FIG. 4. This signal is outputted to an integrator unit 110 that is connected to a memory unit 112 and a camera interface 114 in the same way as illustrated in FIG. 5. For a more detailed description of the elements being identical to those depicted in FIG. 5 please refer thereto. However it should be noted that in the embodiment depicted here the integrator unit 110 may be implemented more simple than that of FIG. 5, as there are not two independent input signals, but just one that further already closely corresponds to the integration method described in FIG. 4. Therefore when using such an integration method the integrator unit 110 will not have to really “process” the input signal in order to derive the integrated video stream, but just perform very basic signal conversion. However, the integrator unit 110 may of course also operate using the other integration methods according to the invention, if this is required.

FIG. 7 shows yet another embodiment of the arrangement of two cameras according to the invention. Two camera modules, each comprising an optic and an image sensor, respectively, are provided in a housing 10, pointing in different directions, for example being oriented at 180° to on another, i.e. “back to back” for capturing images from opposite viewpoints. Each module captures a video stream, and the two video streams are then outputted to an integrator unit 110 being coupled to a memory unit 112 and a camera interface 114. The latter three elements have already been described before. While the arrangement depicted here requires two complete camera modules, i.e. two complete sets of optic and image sensor, this embodiment may thus rely on corresponding conventional units.

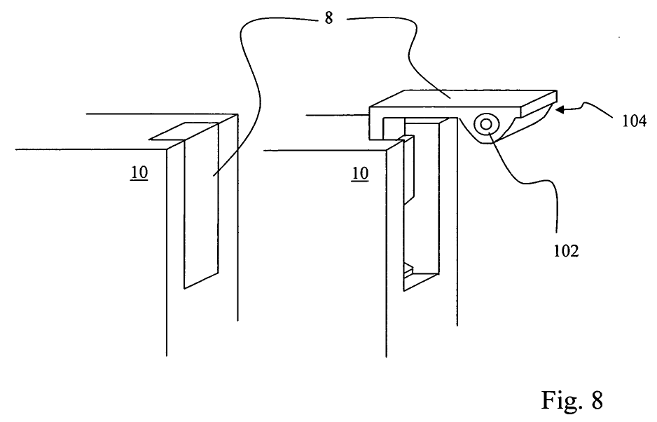

FIG. 8 shows an embodiment of the two-camera solution according to the present invention. A retractable hinge-like element 8 is provided in a housing of a mobile electronic device 8. In the hinge element 8 two cameras 102, 104 are arranged (wherein camera 104 points in the direction opposite to that of camera 102 and is this not visible here). The hinge element may be folded in when the user does not wish to use the cameras. In this fashion the cameras 102, 104, particularly the lenses, will be protected from dirt and scratching. Also the corresponding device will be more compact and provide a “smoother” appearance as no protruding parts are visible. On the hinge element 8 an activation switch (not shown) may be provided. Such a switch can be used for example to activate/power on the camera hardware and to automatically initialize the camera application in the electronic device, and/or to terminate the camera application when the hinge element 8 is closed. The automatic activation of the respective camera application, e.g. a video clip recording or photographing application, conveniently enables a user to immediately take pictures or record videos.

It should be noted that, though the above description did focus on the exemplary use case with two cameras and thus two video streams, the inventive concept is of course also applicable to any greater number of cameras and video streams.

1. Method for handling video streams of two or more cameras in an electronic device, comprising:
capturing at least first and second video streams by first and second cameras, and
integrating said first and second video streams into an integrated video stream.

2. Method according to claim 1, wherein said integrating is performed by
generating said integrated video stream, wherein frames of said integrated video stream are alternately provided by frames of said at least first and second video streams, respectively.

3. Method according to claim 1, wherein said integrating is performed by
generating said integrated video stream, wherein sections of a frame of said integrated video stream are provided by sections of frames of said at least first and second video streams, respectively.

4. Method according to claim 3, wherein said sections are arranged adjacent to each other.

5. Method according to claim 1, wherein said integrating is performed by
generating an integrated video stream, wherein lines of a frame of said integrated video stream are alternately provided by lines of frames of said at least first and second video streams, respectively.

6. Method according to claim 1, further comprising
processing said integrated video stream.

7. Method according to claim 1, further comprising
separating said integrated video stream into first and second output video streams corresponding to said first and second video streams, respectively, to render said first and second output video streams available for further processing, storing or displaying.

8. Computer program product comprising program code means for carrying out the method of claim 1, when said program product is run on a computer or network device.

9. Computer program product comprising program code means embodied on a computer readable medium for carrying out the method of claim 1, when said program product is run on a computer or network device.

10. Computer program product comprising program code, downloadable from a server for carrying out the method of claim 1, when said program product is run on a computer or network device.

11. Electronic device, comprising:
at least first and second optics;
at least first and second image sensors, wherein said first image sensor is associated with said first optic and said second image sensor is associated with said second optic, said image sensors being adapted for capturing at least first and second video streams, respectively; and
a video integrator unit being adapted for generating an integrated video stream of said at least first and second video streams.

12. Electronic device according to claim 11, wherein said video integrator unit is adapted for
generating said integrated video stream such that frames of said integrated video stream are alternately provided by frames of said at least first and second video streams, respectively.

13. Electronic device according to claim 11, wherein said video integrator unit is adapted for
generating said integrated video stream such that sections of a frame of said integrated video stream are provided by sections of frames of said at least first and second video streams, respectively.

14. Electronic device according to claim 11, wherein said video integrator unit is adapted for
generating said integrated video stream such that lines of a frame of said integrated video stream are alternately provided by lines of frames of said at least first and second video streams, respectively.

15. Electronic device according to claim 11, further comprising a video processing unit adapted for processing said integrated video stream.

16. Electronic device according to claim 11, further comprising a camera interface for enabling access to said integrated video stream by an application engine of said mobile electronic device.

17. Electronic device according to claim 11, further comprising a video separator unit adapted for separating said integrated video stream into first and second output video streams corresponding to said first and second video streams, respectively, to render said first and second output video streams available for further processing, storing or displaying.

18. Electronic device according to claim 11, wherein said first and second image sensors are combined into an integral image sensor.

19. Electronic device according to claim 11, further comprising a deflection element for directing the views viewed by said first and said second optic to said first and said second image sensor, respectively.

20. Electronic device according to claim 11, further comprising a housing, and wherein said first and second optics are incorporated into a retractable element settable to at least a first and a second position, wherein said optics are at least partially retracted into said housing in said second position and are operable in said first position.

21. Electronic device according to claim 20, further comprising a switch being adapted to be actuated when said retractable element is set into said first position, or when said retractable element is set into said second position, or both.
